(19) United States
(12) Patent Application Publication
(10) Pub. No.: US 2006/0064864 A1
(43) Pub. Date: Mar. 30, 2006

(54) Device and method for removing tooth applications such as brackets

(75) Inventors: Rolf Meissner, Gilly (CH); Andreas Menne, Signy (CH)

Correspondence Address: OSTROLENK FABER GERB & SOFFEN, 1180 AVENUE OF THE AMERICAS, NEW YORK, NY, 100368403, US

(73) Assignee: Ferton Holding S.A.

(21) Appl. No.: 11/235,790

(22) Filed: Sep. 26, 2005

(30) Foreign Application Priority Data
Sep. 27, 2004 (DE) 10 2004 046 848.6

(51) Int. Cl. B23P 19/04; B23P 19/00

(52) U.S. Cl. 29/426.5; 29/244

(57) ABSTRACT

A device and method for removing tooth applications such as brackets, wherein a force may be applied to the application via a transmission element for debonding the application from the tooth. The transmission element has an impulse conductor for receiving and transmitting an impulse, and an output surface for transmitting the impulse onto the application. Advantageously, the impulse is applied by an accelerated mass to an input surface of the transmission element. The mass is accelerated to a predetermined impact velocity by an acceleration device and impacts on the input surface so as to couple the impulse into the impulse conductor of the transmission element.

### BACKGROUND OF THE INVENTION

1. Field of the Invention

The present invention relates to a device and method for removing tooth applications such as brackets, employing a transmission element for transmitting a force to the application, whereby the application is debonded from the tooth.

2. Related Art

Methods and devices of this type are known for example from U.S. Pat. No. 6,382,965 B 1. For the medical or cosmetic treatment of teeth it is often necessary to affix tooth applications like brackets, jewelry stones or other parts to the outer surface of a tooth using an adhesive. Brackets are part of dental braces and are also referred to as orthodontic clips. It is their function to receive the arch wire of a dental brace so that the exerted force will move the tooth to the desired position. For these purposes, the tooth applications must be sufficiently firmly and permanently attached to the tooth. Depending on the medical or cosmetic application, materials such as metal, plastic, ceramics or combinations of these are used.

It is known from U.S. Pat. No. 6,382,965 B1 to use specially formed pliers for removing tooth applications, the pliers serving to lever or pivot and thereby pry the brackets from the tooth face. A bracket shown in EP 0 656 195 B1 is provided with a groove including a frangible web serving as a predetermined breaking point. When removing the bracket, part of the adhering surface is lifted off the tooth face by compressing the outer parts with the pliers, but the bracket is thereby destroyed.

These kinds of methods for removing tooth applications exert relatively strong forces on the tooth face. Due to the firm attachment to the tooth, debonding of such tooth applications is laborious and is often felt to be very painful by the customer or patient. In addition, parts of the adamantine may also be removed, or dental crowns damaged. Further, the back portions of the pharynx are difficult to access with the pliers, so that these methods can not be well used there.

EP 0 456 401 suggests heating the bracket to thereby weaken the adhesive connection and facilitate debonding. A disadvantage of this technique is that heating of human tissue is always hazardous. The device described therein further requires brackets especially adapted for this application, which generally have to consist of metal since plastics and ceramics do not conduct heat well.

The known devices and methods allow only partial recycling of the brackets for further use due to the mechanical damage occurring during the removal. Jewelry stones may also be damaged by removal, preventing re-use of the stones. However, recycling is desirable for cost reasons.

### SUMMARY OF THE INVENTION

The current invention, however, can provide painless, simple and quick debonding of tooth applications, which does not cause damage to the tooth or to the tooth applications.

According to a particularly advantageous feature of the invention, an application removing device has a transmission element which includes an input surface and an impulse conductor for receiving and transmitting an impulse, and an output surface which transmits the impulse to the application, whereby the application is debonded from the tooth.

The device for removing tooth applications according to this aspect of the invention uses a transmission element for transmitting a force to the application, thereby debonding the application from the tooth. According to other aspects of the invention, the transmission element is provided with an impulse conductor for conducting an impulse to an output surface of the impulse conductor, the output surface transmitting the impulse to the application. The output surface of the impulse conductor abuts the outer face of the application, thereby allowing lossless transmission of the impulse onto the application. The strength of the impulse may be adapted individually to the tooth application used. Depending on the adhesive or material of the tooth application, the impulse may be adapted in amplitude and frequency to provide a desired impact or pressure wave according to the tooth application.

According to a first embodiment of the present invention, the transmission element has an input surface, acted upon by a mass, wherein the mass is accelerated to a pre-determinable impact velocity by an acceleration device and, at its impact onto the input surface, couples the impulse into the impulse conductor of the transmission element. Depending on the mass and pre-determinable impact velocity, i.e. the acceleration of the mass, the amplitude and frequency of the impulse may be adjusted. The mass ratio between the accelerated mass and the transmission element, which may be composed of several parts, may also be used for adjustment. Hence it is possible, for example, to provide the input surface directly at the impulse conductor, so that the impulse is directly transmitted through the impulse conductor to the output surface.

The input surface may be arranged facing in either the proximal or the distal direction, for driving the output surface either toward or away from the patient's pharynx.

In another embodiment of the invention, the transmission element may be provided with an intermediate element arranged between the impulse conductor and the input surface, which preferably includes the input surface, such that the impulse conductor may be interchangeable and may be mounted on the intermediate element in such a way that the impulse is transmitted via the intermediate element to the impulse conductor. The impulse conductor can then quickly be removed for cleaning. The input surface is advantageously arranged at the intermediate element of the transmission element. The frequency and amplitude of the impulse may be adjusted according to the design and the type of the intermediate element.

The impulse conductor and the mass may advantageously be made of a hardened metal alloy such as a steel-titanium-alloy. In case the transmission element includes an intermediate element in addition to the impulse conductor, a different metal or a different alloy may be used for the intermediate element, for example, such that the impulse is dampened by internal deformation of the intermediate element, thereby generating for example a smaller frequency at the output surface while maintaining the same amplitude.

According to a particularly advantageous embodiment of the invention, the mass is movable within a cylinder, and the cylinder is aligned coaxially to the proximal end of the impulse conductor. The transmission element includes the impulse conductor having input and output surfaces, and the accelerated mass impinges on the proximal end, i.e. the input surface of the impulse conductor. At the proximal end of the cylinder facing away from the input surface of the transmission element, a pressure source acts on the mass in order to accelerate the mass to the pre-determinable impact velocity.

After the mass has coupled its kinetic energy into the impulse conductor in the form of an impulse, a retracting device retracts the mass in the direction of the pressure source after its impact onto the input surface. The pressure source and the retracting device may be gravitational, mechanical, pneumatic, hydraulic, electromagnetic or electromechanical. A mechanical device such as a biased spring may also be used for accelerating the mass. If the gravitational force is to be used for providing acceleration, the mass may be situated, for example, in a vertical column standing beside the operator and connected to the handpiece by a suitable pressure-transmitting conduit.

The transmission element and/or the cylinder are advantageously mounted resiliently or with damping inside a casing, such that none or little of the impulse is transmitted to the casing, which is generally held in the hand of the operator. The impulse conductor is preferably made of a metal and has a blunt output surface adapted to the surface of the application and thereby transmits the impulse to the application nearly without loss. For complicated applications in the back portion of the mouth, the impulse conductor may be curved.

According to a further advantageous embodiment of the invention, a setting element is provided between the transmission element and the mounting casing, wherein the setting element returns the transmission element to the input surface after the impact of a mass, and/or controls and limits the displacement of the transmission element. The setting element may be used at the same time to journal the transmission element or may have a sleeve-like intermediate element, which serves to journal as well as to dampen and adjust the impulse, and to retract the transmission element after the impact of the mass.

Advantageously, the proximal end or another portion of the impulse conductor may have a collecting device for capturing the debonded application. Involuntary swallowing of the application is thus prevented. The impulse conductor may be curved or otherwise arranged so as to direct the debonded application toward the proximal end of the impulse conductor. Advantageously, the impulse may be transmitted so as to direct the debonded application toward the proximal end of the impulse conductor.

According to a further advantageous embodiment of the present invention, the transmission element has an input surface acted upon by a piezoelectric element, such that the impulse is coupled by means by the piezoelectric element into the impulse conductor. Again, amplitude and frequency of the impulse may be determined according to the design of the piezoelectric element and the electric power.

Advantageously, the impulse conductor transmits an impulse in the form of a pressure wave or impact energy to the output surface, such that the output surface transmits a pre-determinable stroke preferably of 10μ to 2000μ, in particular 10μ to 500 μm, onto the application which is thereby debonded from the tooth. The application is, so to speak, “knocked off” the tooth by a short impulse stroke. Surprisingly, it has been demonstrated that tooth applications such as brackets of braces may be removed safely, quickly and nearly painlessly from the tooth by this method, without damaging the tooth. The bracket removed in this way may generally be re-used.

The present invention also relates to a method of removing tooth applications such as brackets, wherein a force is applied to the application by a transmission element, thereby debonding the application from the tooth. The method is characterized in that the impulse is transmitted to the application by an impulse conductor which transmits an impulse coupled into an input surface of the transmission element. It is also possible to transmit a series of impulses in pre-determinable time intervals.

The impulse is coupled by the deceleration of the mass at the input surface of the transmission element into the proximal end of the impulse conductor, possibly via an intermediate element, and is coupled out through a distal output surface of the impulse conductor by the acceleration of the application. The output surface thereby contacts the surface of the application. The output surface may be driven by the mass in either the distal or the proximal direction.

Other features and advantages of the present invention will become apparent from the following description of embodiments of invention which refers to the accompanying drawings.

### BREIF DESCRIPTION OF THE DRAWINGS

An embodiment of the present invention will be described in greater detail with reference to the appended drawings, in which:

FIG. 1 is a cross-sectional view of an embodiment of a device according to the invention,

FIG. 2 is an embodiment of an impulse conductor according to the invention,

FIG. 3 is an embodiment of a transmission element having a special output surface, and

FIG. 4 is another embodiment of a transmission element having a special output surface.

### DETAILED DESCRIPTION OF EMBODIMENTS OF THE INVENITON

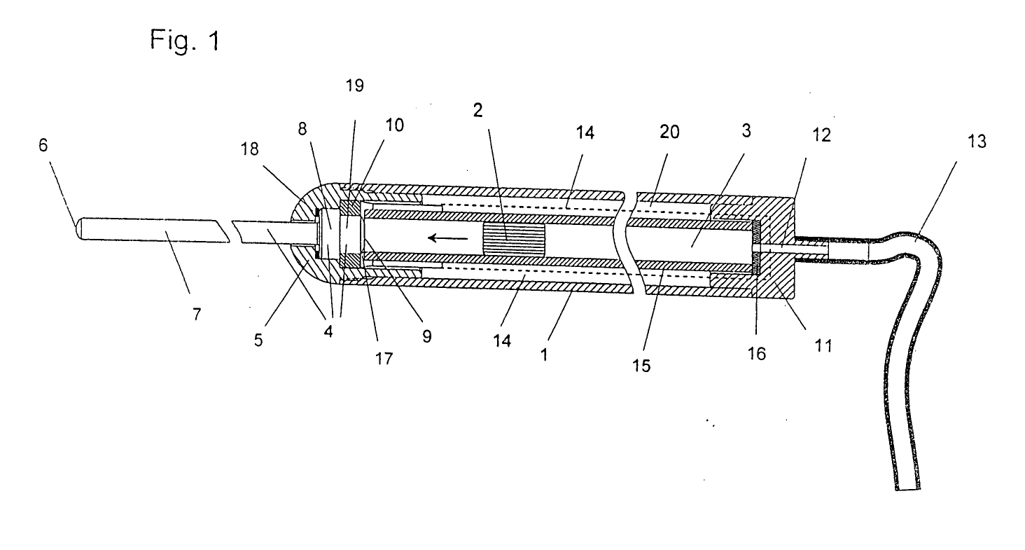

FIG. 1 shows a transmission element 4 having an impulse conductor 7 including an output surface 6 and an input surface 9. The transmission element 4 includes a guide element 8 by which it is mounted inside the distal cap 5, which is removably attached to a casing 1, such as by a screw-on or a plug-in mechanism. The guide element 8 is preferably a suitably adapted proximal end of the impulse conductor 7, which is axially and radially journaled by means of a corresponding cross-sectional enlargement in the distal cap 5.

A cylinder 15 in which a mass 2 is moveably suspended, is disposed coaxially to the transmission element 4. In the displacement space 3 inside the cylinder 15, mass 2 may move from a proximal stop 16 to the input surface 9 of the transmission element 4. Stop 16 is connected to a port 12, to which a supply line 13 may be connected. For example, pneumatic or hydraulic pressure fluids may be fed through the supply line to accelerate the mass 2 in the direction of the input surface 9.

The air or fluid medium in front of mass 2 may escape through an annular aperture 17 between the transmission element 4 and the cylinder 15 into a pressure chamber situated between the cylinder 15 and the casing 1. The proximal end of the cylinder 15 is preferably detachably connected via a proximal cap 11 to the casing 1. The distal end of the cylinder 15 is journaled either by a bushing 10 further serving to fix the transmission element 4, or by the conical shape of the input surface 9 shown in FIG. 1. Bushing 10 serves to further journal the transmission element 4 axially and radially inside the distal cap 5.

Between the transmission element 4 and the distal cap 5 is an embedded setting element 18 for limiting and controlling the displacement of the transmission element 4 during impact of mass 2. The setting element 18 may be an O-ring made of metal or an elastic material such as a plastic. The setting element 18 is exchangeably inserted into a corresponding groove of cap 5, which also journals the guide element 8 of the transmission element 4.

The impulse conductor 7 has an elongated form to ensure easy access to the tooth application and unimpaired view of the treatment area. An output surface 6 is arranged such that it may be conveniently applied to the tooth application.

Of particular advantage is the provision of an intermediate element 19 as part of the transmission element 4. The intermediate element 19 is mounted between the impulse conductor 7 and the input surface 9 and preferably includes the input surface 9 itself, so that the impulse conductor 7 is exchangeably mountable on the intermediate element 19. The impulse conductor may then be quickly removed for cleaning and disinfection. For this purpose, cap 5 may have two parts, so that the front part including the impulse conductor may be taken off, while the rear part serves to mount the intermediate element 19 and the bushing 10 on the cylinder 15.

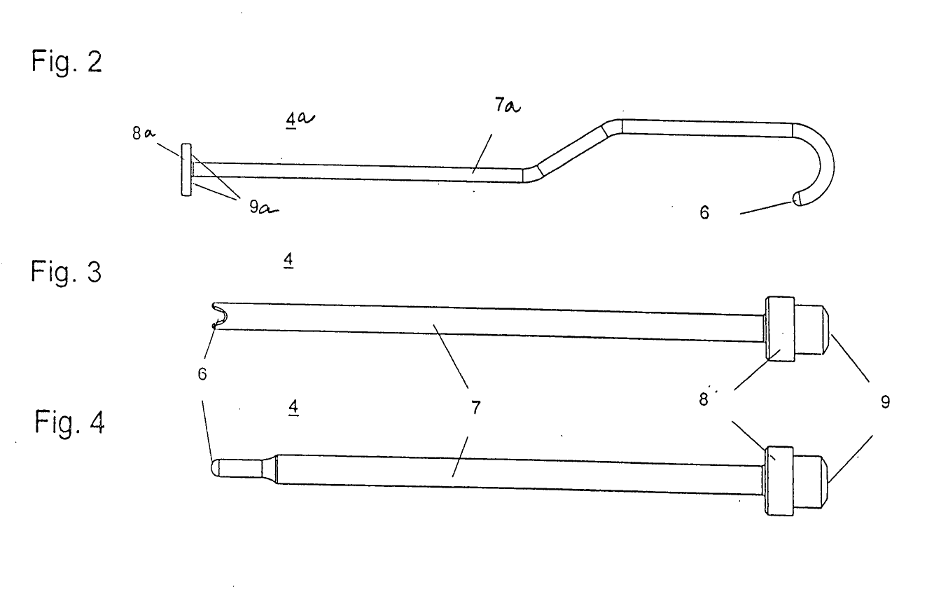

FIG. 2 shows a special embodiment of a transmission element 4a having a curved impulse conductor 7a with an output surface 6 and a guide element 8a which is e.g. screwed or plugged into the impulse conductor 7a. The guide element 8a further includes an input surface 9a onto which the impulse is coupled. In this embodiment, the input surface 9a is situated on the distal side of the guide element 8a, i.e. at the side facing the impulse conductor 7a. For this purpose, the guide element 8a is located at the proximal end of the cylinder 15, and the mass 2 has a central bore (not shown) and moves as on a rail on the impulse conductor 7a or a suitable intermediate element from the distal end to the proximal end of the cylinder 15, where it impinges on the input surface 9. A suitable stop (not shown) and the supply for compressed air are then mounted at the distal end of the cylinder (not shown).

Where appropriate the compressed air may also be supplied to the distal end via a two-part, cup-shaped pressure chamber 14 from the proximal end in an outer annular region 20 (indicated by a dashed line in FIG. 1). That is, the pressure chamber 14 in this embodiment is constructed in the form of two half-cylinders, which are separable along a longitudinal plane.

With this transmission element, due to the curvature of the impulse conductor 7a, tooth applications may easily be removed in the direction of the mouth opening, even from the back portion of the mouth.

FIGS. 3 and 4 show special embodiments of the transmission element 4, including impulse conductor 7, guide element 8 and input surface 9. The output surface 6 may be circular, concave or convex, or may have a specially formed receiving opening for being applied to the tooth application in such a way that the impulse conductor finds an ideal contact geometry at the application. With any of these, a blunt output surface is preferred, since pointed geometries rather tend to destroy the bracket.

To protect the tooth from accidental impact of the impulse conductor 7, the output surface 6 may be formed to be asymmetrical with respect to its rotation axis, for example as a blunt screw driver-shape having a blade parallel to the tooth face at a few millimeters distance from the tooth.

Due to the exchangeability of the distal cap 5, different impulse conductors 7 for respective tooth applications to be removed may be inserted into the same casing 1.

The embodiment shown in FIG. 1 has a pneumatic drive, wherein compressed air is fed through the supply line 13 into the cylinder 15 and accelerates the mass 2 in the direction of the impulse conductor 7. The air escapes through the annular aperture 17 into pressure chamber 14, allowing the mass 2 to be returned to its initial position after impinging on the input face 9. Optionally, the stop 16 may be magnetic for retracting the mass 2 to its initial position. An O-ring made of rubber is used as setting element 18, so that the transmission element 4 is resiliently mounted with respect to the casing or the cap. Transfer of the impulse onto the casing 1 is thereby avoided, and the total stroke of the impulse conductor 7 and the transmission element 4 may thus be adjusted.

After impact of the mass 2, the transmission element 4 is returned to its initial position by the setting element 18. In addition, the inside of the casing is sealed by the sealing function of the O-ring setting element 18.

The pneumatic components such as pressure reducer, control valves and indicating instruments necessary for generating the compressed air pulse for acceleration of mass 2 may be disposed in a separate table housing. The casing with mass 2 and impulse conductor 7 is then connected via the flexible supply line 13 with the table housing. For reasons of simplicity, these components may also be accommodated inside the casing 1, which then contains all necessary components for generating the pulse. The port 12 for compressed air could then be implemented by a turbine connection or by an integrated compressed air cartridge (not shown). The latter embodiment does not contain any supply line. The apparatus may be operated stand-alone and may even be used in mobile applications.

Expediently, the device is adapted for a series of several single impulses. In an advantageous embodiment, mass 2 may therefore return to its initial position by itself. Besides the pressure chamber 14 or the magnetic stop 16 described above, a spring provided inside the cylinder 15 may also be used for returning the mass 2. Mass 2 may be an elongated or spherical projectile made from hardened metal.

By designing the distal cap 5 to be removable, the transmission element 4 may be easily taken off for reasons of hygiene and thus easily cleaned, disinfected and sterilized. An implementation as single-use article is also contemplated. The proximal cap 11 can also be exchangeable in order to allow the connection of different pressure sources.

It has been found that after debonding the tooth application, the tooth application or parts thereof may fly around. The patients could swallow these or even get them inside his airways. Due to the arrangement of the input surface 9a and the curved embodiment of the impulse conductor 7a shown in FIG. 2, the impulse is aimed in the proximal direction toward the housing 1, so that the debonded application does not fall into the pharynx, but instead in the direction of the device. A further embodiment of the present invention is the provision of a capture or holding device for the removed tooth application (not shown).

Although the present invention has been described in relation to particular embodiments thereof, many other variations and modifications and other uses will become apparent to those skilled in the art. Therefore, the present invention is not limited by the specific disclosure herein.

What is claimed is:

1. A device for removing tooth applications such as brackets, having a transmission element for transmitting a force to the application, whereby the application is debonded from the tooth, characterized in that the transmission element includes an impulse conductor for receiving and transmitting an impulse and an output surface for transmitting the impulse onto the application.

2. The device according to claim 1, characterized in that the transmission element is provided with an input surface for being acted upon by a mass, and an accelerating device for accelerating the mass to a pre-determinable impact velocity, such that the mass impacts on the input surface and couples the impulse into the impulse conductor of the transmission element.

3. The device according to claim 1, characterized in that the transmission element is provided with an input surface coupled to a piezoelectric element such that the impulse is coupled into the impulse conductor by the piezoelectric element.

4. The device according to claim 1, characterized in that the output surface transmits a pre-determinable stroke of substantially 10μ to 2000μ to the application, such that the application is debonded from the tooth.

5. The device according to claim 2, characterized in that the accelerating device comprises a cylinder, the mass is movable inside the cylinder and the cylinder is disposed coaxially to a proximal end of the impulse conductor, and a pressure source acts on the mass at the proximal side of the cylinder in a distal direction toward the transmission element and thereby accelerates the mass in the distal direction to the pre-determinable impact velocity.

6. The device according to claim 5, characterized in that a magnetic stop is disposed at the cylinder for retracting the mass after its impact on the input surface.

7. The device of claim 6, characterized in that the transmission element and the cylinder are mounted inside a casing, and a damping device is provided at the casing for reducing transmission of the impulse to the casing.

8. The device according claim 5, characterized in that the proximal end of the impulse conductor is journaled inside a bushing which annularly encloses the distal end of the cylinder and is mounted inside the casing, so that the air displaced by the mass during acceleration may escape from the cylinder.

9. A device according to claim 8, characterized in that a distal cap is removably mounted on the casing so that the impulse conductor is exchangeable.

10. The device according to claim 5, characterized in that the accelerating device and transmission element are mounted in a casing, and a setting element is located between the transmission element and the casing.

11. The device according to claim 10, wherein the setting element retracts the transmission element after the impact of mass on the input surface.

12. The device according to claim 10, wherein the setting element limits the displacement of the transmission element.

13. The device of claim 5, characterized in that the transmission element and the cylinder are mounted inside a casing, and a damping device is provided at the casing for reducing transmission of the impulse to the casing.

14. The device according to claim 5, further comprising a retracting device which moves the mass back in the direction of the pressure source after its impact on the input surface.

15. The device according to claim 2, characterized in that the accelerating device comprises a cylinder, the mass is movable inside the cylinder and the cylinder is disposed coaxially to a proximal end of the impulse conductor, and a pressure source acts on the mass at the distal side of the cylinder in a proximal direction away from the transmission element and thereby accelerates the mass in the proximal direction to the pre-determinable impact velocity.

16. The device according to claim 2, characterized in that the transmission element has an intermediate element mounted between the impulse conductor, and the intermediate element includes the input surface.

17. The device according to claim 16, wherein the impulse conductor is exchangeably journaled at the intermediate element.

18. The device according to claim 1, characterized in that the impulse conductor comprises a metal and is provided with a blunt output surface adapted to the surface of the application.

19. The device according to claim 1, characterized in that the impulse conductor is curved.

20. A method for removing tooth applications such as brackets, wherein a force is exerted on the application by a transmission element so that the application is debonded from the tooth, comprising the steps of:
receiving an impulse coupled into an input surface of the transmission element; and
transmitting the impulse onto the application via an impulse conductor of the transmission element.

21. The method according to claim 20, characterized by the transmission of a series of impulses in pre-determinable time intervals.

22. The method according to claim 20, characterized in that the impulse is coupled into the proximal end of the impulse conductor by the deceleration of a mass at the input surface of the transmission element, and is coupled out of a distal output surface of the impulse conductor for debonding the application, by contacting the output surface with a surface of the application.

23. The method according to claim 22, further comprising the step of capturing the debonded application.

24. The method according to claim 22, characterized in that the output surface transmits a pre-determinable stroke of substantially 10μ to 2000μ to the application, such that the application is debonded from the tooth.

25. The method according to claim 22, further comprising the step of accelerating the mass to a predetermined impact velocity.

26. The method according to claim 22, further comprising the step of providing a blunt output surface adapted to the application to be debonded, so as to reduce impulse transmission losses.

27. The device according to claim 19, wherein said impulse conductor is curved so as to direct the debonded application toward the proximal end of the impulse conductor.

28. The device according to claim 1, wherein said impulse conductor transmits said impulse so as to direct the debonded application toward the proximal end of the impulse conductor.

29. The method according to claim 23, wherein said debonded application is captured at the proximal end of the impulse conductor.

30. The method according to claim 20, wherein said impulse is transmitted so as to direct the debonded application toward the proximal end of the impulse conductor.

31. The device according to claim 2, wherein said accelerating device applies one or more of a gravitational, mechanical, pneumatic, hydraulic, electromechanical and electromagnetic force to the mass.
